(19) United States
(12) Patent Application Publication
(10) Pub. No.: US 2026/0278034 A1
(43) Pub. Date: Sep. 17, 2026

(54) Systems And Methods For Predicting Future Events For A Temporal Point Process

(71) Applicant: Royal Bank of Canada, Toronto (CA)

(72) Inventors: Amartya Mukherjee, Toronto (CA); Ruizhi Deng, Toronto (CA); He Zhao, Toronto (CA); Yuzhen Mao, Toronto (CA); Leonid Sigal, Toronto (CA); Frederick Tung, Toronto (CA)

(21) Appl. No.: 19/080,175

(22) Filed: Mar. 14, 2025

(51) Int. Cl. G06F 17/13; G06N 3/0455

(52) U.S. Cl. CPC G06F 17/13; G06N 3/0455

(57) ABSTRACT

A diffusion model is used to generate events from a temporal point process (TPP) sequence. The diffusion model uses an asynchronous noise schedule. The TPP sequence is first mapped to a latent space and the diffusion model generates events in the latent space which are then mapped back to events.

### TECHNICAL FIELD

The current disclosure relates to generating future events for a temporal point process (TPP), and in particular to generating the future events based on a diffusion process.

### BACKGROUND

Diffusion models have emerged as a powerful framework in generative modeling, achieving remarkable success in domains such as image synthesis and video generation. Event sequence modeling for temporal point processes (TPPs) using diffusion models can be difficult as result of the characteristics of TPPs. For example, TPPs often include mixed data types including continuous attributes such as timestamps or durations with non-continuous data types such as categorical information of event types. Further, many existing diffusion models assume a fixed dimension of data, whereas the lengths of observation and prediction windows in TPP sequences can vary widely.

Applying current diffusion model based techniques to TPP sequences is difficult and can be computationally complex. An additional, alternative and/or improved diffusion-based model that is applicable to TPP sequences is desirable.

### BRIEF DESCRIPTION OF THE DRAWINGS

Further features and advantages of the present disclosure will become apparent from the following detailed description, taken in combination with the appended drawings, in which:

FIG. 1 depicts a diffusion-based process for predicting future events for a TPP sequence;

FIG. 2 depicts a training process for a diffusion model for use in predicting future events for a TPP sequence;

FIG. 3 depicts predicting future events for a TPP sequence using a diffusion model;

FIG. 4A depicts applying a synchronous noise schedule to a plurality of latent events;

FIG. 4B depicts applying an asynchronous noise schedule to a plurality of latent events;

FIG. 5 depicts an asynchronous noise schedule;

FIG. 6 depicts a method of generating future events for a TPP sequence using a diffusion model; and

FIG. 7 depicts systems for training and using a diffusion model with TPP sequences.

### DETAILED DESCRIPTION

In accordance with the present disclosure there is provided a method of generating a plurality of predicted events in a time series, the method comprising: receiving an observation series of events, z, comprising a plurality of events each associated with an event type of a plurality of defined event types and an event time, where: z={z⁽¹⁾, z⁽²⁾, . . . , z^{(N)}}; z^{(N)}; z⁽ⁱ⁾=(τ⁽ⁱ⁾, k⁽ⁱ⁾; k⁽ⁱ⁾ is the event type of the ith event; and τ⁽ⁱ⁾ is an event time of the ith event; generating a latent event sequence, x, by encoding each event of the observation series of events to corresponding observation latent events in a latent space using a trained encoder, E_{Ø}, of a variational autoencoder, where: x={x⁽¹⁾, x⁽²⁾, . . . , x^{(N)}}; x⁽ⁱ⁾=E_{Ø}(z⁽ⁱ⁾) generating a noise sample ϵ{ϵ₁, . . . , ϵ_{N+h}}, where h is a number of events to predict; denoising the noise samples to generate a series of h latent events using a diffusion model conditioned on the received observation series x, the diffusion model applying an asynchronous noise schedule to denoise different samples at different rates; and decoding the h latent events to a prediction series of events using a trained decoder, D_{ψ}, of the variational autoencoder.

In a further embodiment of the method, denoising the noise samples generates a latent event sequence y={y⁽¹⁾, y⁽²⁾, y^{(N+h)}}, where {y⁽¹⁾, y⁽²⁾, . . . , y^{(N)}}={x⁽¹⁾, x⁽²⁾, . . . , x^{(N)}} and {y^{(N+1)}, . . . , y^{(N+h)}} are the predicted h latent events.

In a further embodiment of the method, the asynchronous noise schedule, A(s), is a diagonal-matrix-valued time-varying coefficient.

In a further embodiment of the method, A(s)∈(H¹[0,1])^{n×n}.

In a further embodiment of the method, A(0)=I; A(1)=0; A(s) is positive semi-definite for all s∈[0,1]; ∥A(s)x∥≤∥A(s′)x∥ for all x∈ [symbol] ⁿ if s≥s′; and A(s) is continuous and weakly differentiable for all s∈[0,1].

In a further embodiment of the method, denoising the noise samples comprises solving an ordinary differential equation (ODE): \dot{x}ₛ=v_{θ}(xₛ,s); where: \dot{x}ₛ is a denoised latent event at flow time s; and v_{θ}(xₛ,x) is a learnable function modeling a vector field that generates a probability path between data x₀ and Gaussian noise x₁.

In a further embodiment of the method, h≥1.

In a further embodiment of the method, the h latent events are generated over time steps between s=s_{end} and s=sₛₜₐᵣₜ where s_{end}≤1 and sₛₜₐᵣₜ≥0.

In a further embodiment of the method, at least one of: s_{end}≤1; and sₛₜₐᵣₜ≥0.

In a further embodiment of the method, the h latent events are fully denoised at s=sₛₜₐᵣₜ.

In a further embodiment of the method, the noise sample is Gaussian noise.

In accordance with the present disclosure there is further provided a system comprising: a processor for executing instructions; and a memory storing instructions, which when executed by the processor configure the system to perform a method comprising: receiving an observation series of events, z, comprising a plurality of events each associated with an event type of a plurality of defined event types and an event time, where: z={z⁽¹⁾, z⁽²⁾, . . . , z^{(N)}}; z⁽ⁱ⁾(τ⁽ⁱ⁾, k⁽ⁱ⁾); k⁽ⁱ⁾ is the event type of the ith event; and τ⁽ⁱ⁾ is an event time of the ith event; generating a latent event sequence, x, by encoding each event of the observation series of events to corresponding observation latent events in a latent space using a trained encoder, E_{Ø}, of a variational autoencoder, where: x={x⁽¹⁾, x⁽²⁾, . . . , x^{(N)}}; x⁽ⁱ⁾=E_{Ø}(z⁽ⁱ⁾) generating a noise sample ϵ={ϵ₁, . . . , ϵ_{N+h}}, where h is a number of events to predict; denoising the noise samples to generate a series of h latent events using a diffusion model conditioned on the received observation series x, the diffusion model applying an asynchronous noise schedule to denoise different samples at different rates; and decoding the h latent events to a prediction series of events using a trained decoder, D_{ψ}, of the variational autoencoder.

In a further embodiment of the system, denoising the noise samples generates a latent event sequence y={y⁽¹⁾, y⁽²⁾, . . . , y^{(N+h)}}, where {y⁽¹⁾, y⁽²⁾, y^{(N)}}={x⁽¹⁾, x⁽²⁾, . . . , x^{(N)}} and {y^{(N+1)}, . . . , y^{(N+h)}} are the predicted h latent events.

In a further embodiment of the system, the asynchronous noise schedule, A(s), is a diagonal-matrix-valued time-varying coefficient.

In a further embodiment of the system, A(s)∈(H¹[0,1])^{n×n}.

In a further embodiment of the system, A(0)=I; A(1)=0; A(s) is positive semi-definite for all s∈[0,1]; ∥A(s)x∥≤∥A(s′)x∥ for all x∈ [symbol] ⁿ if s≥s′; and A(s) is continuous and weakly differentiable for all s∈[0,1].

In a further embodiment of the system, denoising the noise samples comprises solving an ordinary differential equation (ODE): is \dot{x}=v_{θ}(xₛ,s); where: \dot{x}ₛ is a denoised latent event at flow time s; and v_{θ}(xₛ,x) is a learnable function modeling a vector field that generates a probability path between data x₀ and Gaussian noise x₁.

In a further embodiment of the system, h≥1.

In a further embodiment of the system, the h latent events are generated over time steps between s=s_{end} and s=sₛₜₐᵣₜ where s_{end}≤1 and sₛₜₐᵣₜ≥0.

In a further embodiment of the system, at least one of: s_{end}<1; and sₛₜₐᵣₜ>0.

In a further embodiment of the system, the h latent events are fully denoised at s=sₛₜₐᵣₜ.

Temporal point processes (TPPs) provide a sequence of events and often consist of mixed data types, combining continuous attributes (e.g., timestamps or durations) with categorical information (e.g., event types). It is desirable in many applications to predict or generate future events based on a given sequence of events. Diffusion models have been successfully used in generative modelling. Diffusion models are naturally fit for continuous data and recent endeavors of applying DMs to discrete data types requires non-trivial efforts. While many existing DMs assume a fixed dimension of data, the lengths of sequential data are inherently variable in nature. The lengths of observation and prediction windows in TPP sequences could also varying widely in different prediction tasks such as next-event predictions and long-horizon predictions.

To deal with these challenges, the future events are generated by first encoding the event sequences to corresponding events in a latent space. Diffusion models can be applied to the latent events and then generated latent events decoded into the predicted future events. The latent mappings that can faithfully encode and reconstruct event data can be learned. Diffusion models can be applied to model the joint distribution of the continuous latent representations of event sequences. Further, a general formulation of diffusion models with asynchronous noise schedules based on rectified flows and conditional flow matching is provided. Asynchronous noise schedules apply different degrees of interpolation between data and noise for different events, allowing different events to diffuse/denoise at different time in the diffusion/denoising process. An asynchronous diffusion models denoise events of near future first before generating events of more distant future conditioned on the previous events. Moreover, the process described further below can flexibly control the length of predictions window by choosing the ending time of the denoising process using one diffusion model.

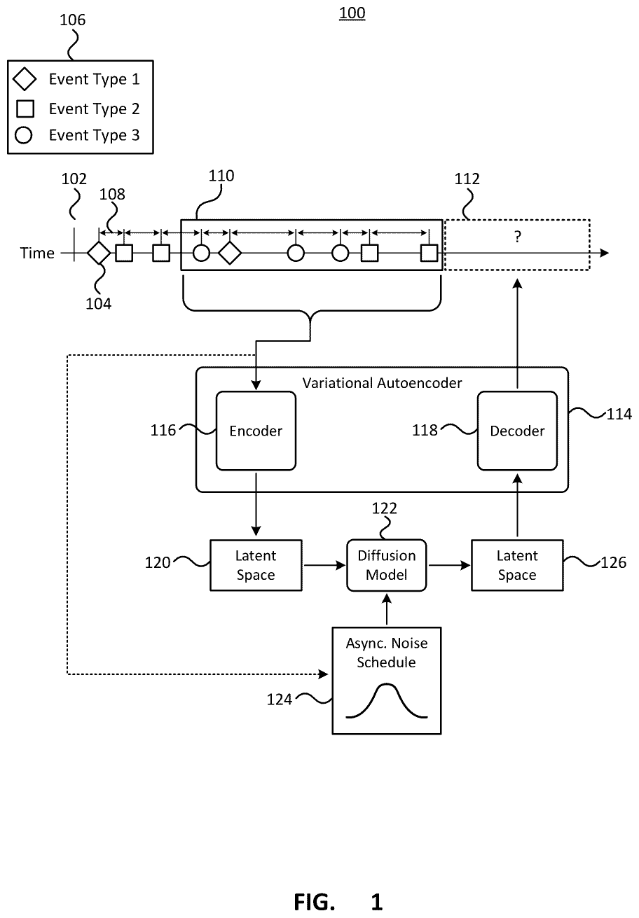

FIG. 1 depicts a diffusion-based process for predicting future events for a TPP sequence. The process 100 can be used to predict or generate future events for a TPP sequence 102. The TPP sequence 102 comprises a plurality of events 104 that occur at respective times. As depicted by the legend 106, each event may be associated with a particular type of event or other categorical data. The sequence may define the time for an event as the arrival time or an inter-arrival time between events 108. A prediction window 110 may comprises a number of the events in the sequence that can be used to predict one or more future events in a prediction window 112.

In order to generate the future events using a diffusion model, which operate on continuous data, a variational autoencoder 114, comprising an encoder 116 and decoder 118, is used to map events to a latent space 120. The encoded latent events can then be applied to a diffusion model 122 that uses an asynchronous noise schedule 124 to generate future latent events in the latent space 126. The diffusion model denoises noisy samples according to the asynchronous noise schedule in order to generate the latent events. The denoising is conditioned on the latent events of the prediction window. The asynchronous noise schedule allows events to be generated with only having to denoise events for a shorter flow time between s=s_{end} and S=sₛₜₐᵣₜ rather than having to denoise the events for the entire time period between s=1 and s=0 as is the case with synchronous noise schedules. The generated latent events can be mapped by the decoder 118 back to the events for the prediction window 112. As described in further detail below, the diffusion model with asynchronous noise schedule can be used to efficiently compute the future events.

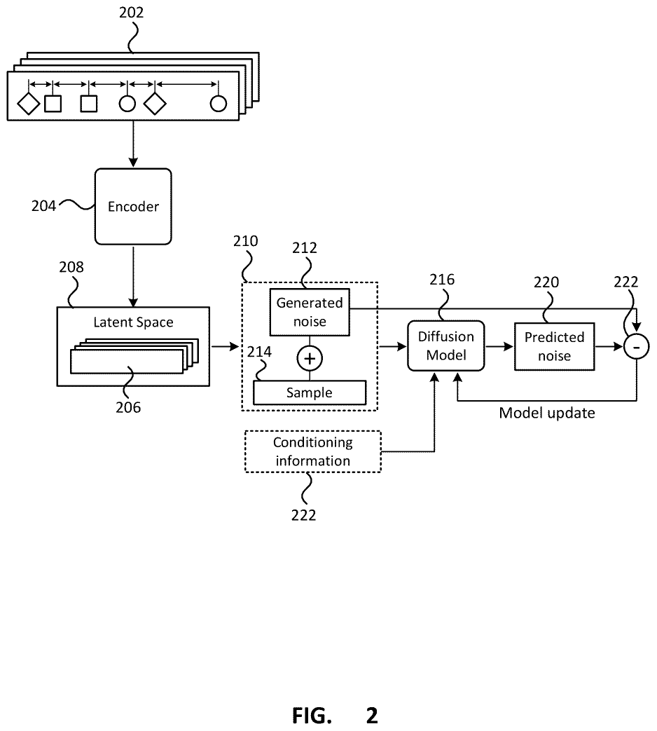

FIG. 2 depicts a training process for a diffusion model for use in predicting future events for a TPP sequence. Training the diffusion model attempts to teach the model how remove noise in order to generate an event. As depicted, the training data 202 comprises a plurality of TPP event sequences. The plurality of event sequences may be from a single data set or may be from multiple different data sets. Regardless, a number of event sequences, comprising a number of events are mapped by an encoder 204 to corresponding latent event sequences 206 in a latent space 208. The latent event sequences are used to generate noised samples 210 by generating noise 212 which is added to a sample 214, such as a latent event or sequence of latent events. The noised samples are applied to the diffusion model 216 being trained, possibly along with conditioning information 218. The conditioning information may take various forms, including for example, the denoised sample 214, or other encodings. The diffusion model predicts the noise 220 that was added to the sample to generate the noised sample 210. By learning to predict the noise that was added to the sample, the diffusion model is also learning what noise to remove to generate a sample. The error 222 between the predicted noise 220 and the actual noise 212 applied can be minimized and use to update the model during the training process. Once trained, the diffusion model with an asynchronous noise schedule can be used to generate future events.

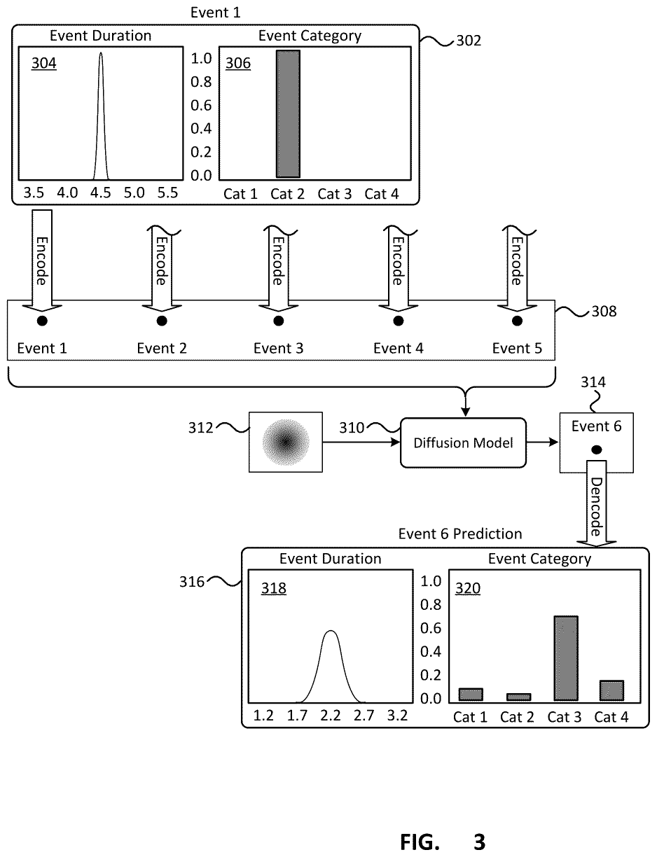

FIG. 3 depicts predicting future events for a TPP sequence using a diffusion model. As depicted in FIG. 3, a plurality of events are encoded. Each event, one or which is depicted 302, may comprise event timing information 304, which may be a time the event occurred at, a duration of the event, a time between events, etc. along with categorical data 306, such as a particular category or type of event. While only a single event category is depicted, which may be selected from a plurality of defined category values, it is possible for the events to have multiple category types along with other types of data. Each event of the TPP sequence is encoded into a corresponding event in latent space 308. The diffusion model de-noises a noise sample 312, conditioned on the latent event sequence 308 to generate a new event 314 in the latent space. The generated latent event 314 can be decoded into a predicted event 316. The event includes the same information as events of the initial event sequence, such as the event timing 318 and event category 320.

A TPP sequence comprises a sequence of events that occur at respective times. Each event may be associated with categorical information as well as time information, such as a timestamp of the event or a length of the event. The TPP sequence may be defined z={z⁽¹⁾, z⁽²⁾, . . . , z⁽ⁿ⁾} which is event sequence of n events with event z⁽ⁱ⁾=(τ⁽ⁱ⁾,k⁽ⁱ⁾) where k⁽ⁱ⁾ is the event type of the ith event and τ⁽ⁱ⁾ denotes the inter-arrival between the ith and i−1th event for i>1 and the time stamp of the first event for i=1.

E_{φ}(⋅) and D_{ψ}(⋅) are an encoder and decoder designed to map events to latent space and back to events. Let x={x⁽¹⁾, x⁽²⁾, . . . } be an event sequence in latent space, where x⁽ⁱ⁾=E_{φ}(z⁽ⁱ⁾) and z⁽ⁱ⁾=D_{ψ}(x⁽ⁱ⁾) assuming a perfect auto-encoder. xₛ represent the diffusion, or reverse diffusion or denoising, of the latent event x:=x₀ at diffusion time s. t is used to refer to time in the event sequence sense and s to refer to time in the diffusion sense to avoid confusion. A(s) is defined to be the asynchronous noise schedule, satisfying A(0)=I and A(1)=0. A flow model v_{θ}(xₛ,A(s)) can be trained to predict x₀−ϵ where ϵ:=x₁ is the Gaussian noise that was initiated for the generation.

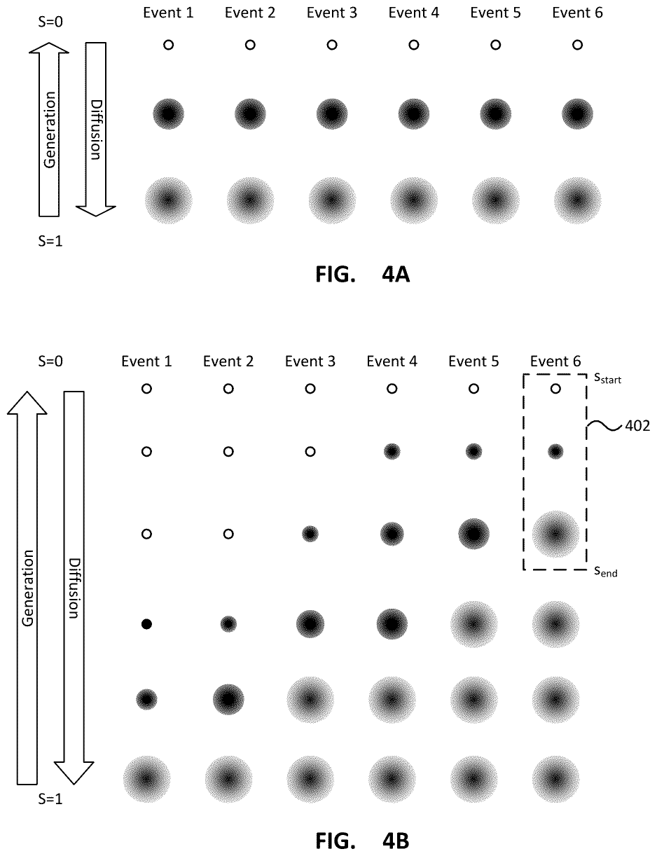

FIG. 4A depicts applying a synchronous noise schedule to a plurality of latent events. The figure depicts different diffusion steps in the diffusion/denoising process using a synchronous noise schedule. In FIGS. 4A, and 4B, the size a blurriness of the circle associated with each event is intended to represent how noisy the data is. As depicted in FIG. 4A, each event is diffused/denoised at the same rate and flow time. Accordingly, in order to generate a new event from noise, all of the events need to be denoised from flow time s=1 to s=0.

FIG. 4B depicts applying an asynchronous noise schedule to a plurality of latent events. As can be seen in FIG. 4B, the noise added to, or removed from, the data at each step in the diffusion/denoising or generation process can differ for each event. During the forward diffusion, clean data are gradually replaced with Gaussian noise with different speeds at different parts of the data. In the generation process, part of the data will be denoised first before the generation of the remainder. As depicted in FIG. 4B it is possible to generate a new event such as event 6 by denoising the Gaussian noise between s=s_{end} and s=sₛₜₐᵣₜ. The generation time 402 between s_{end} and sₛₜₐᵣₜ reduces the computation time required to generate the events since the entire flow time between s=1 and s=0 does not need to be computed.

A TPP is a realization of a stochastic process as discrete events in time. Its realizations comprises a sequence of events with strictly increasing arrival times T={t⁽⁰⁾, . . . , t^{(N)}} or equivalently with strictly positive inter-event times T=

The paper “EasyTPP: Towards Open Benchmarking Temporal Point Processes,” of Xue et al., 2024 (arXiv:2307.08097) the entire contents of which are incorporated herein by reference in their entirety for all purposes provides standardization, benchmarking, and extensibility to the modeling of TPPs. The paper provides 5 datasets and a comprehensive evaluation of nine models on these datasets. In each dataset, an event z⁽ⁱ⁾ comprises an inter-event time τ⁽ⁱ⁾ and a categorical event type k⁽ⁱ⁾ where k⁽ⁱ⁾∈{1, . . . , K}. The models were used to evaluate the diffusion model with asynchronous noise schedule. The model was evaluated with two different criteria. For evaluating next-event prediction, {z⁽⁰⁾, . . . , z⁽ⁿ⁻¹⁾} events from the test set were used to predict the next event z⁽ⁿ⁾=(τ⁽ⁿ⁾,k⁽ⁿ⁾}. The root mean square error (RMSE) of the predicted inter-event time τ⁽ⁿ⁾ and the error rate of the event type k⁽ⁿ⁾ were used to evaluate the performance of the model. For long-horizon prediction, preceding events {z⁽⁰⁾, . . . , z⁽ⁿ⁾} from the test set were used predict the next five and the next ten events {z⁽ⁿ⁺¹⁾, . . . , z^{(n+m)}}. The optimal transport distance (OTD) between the preceding events and the predicted events was used to evaluate the performance of the model in the long-horizon prediction.

The EasyTPP paper provides implementations and evaluations for widely cited models in the field including Multivariate Hawkes Process (MHP), Recurrent marked temporal point process (RMTPP), Neural Hawkes Pro cess (NHP), Self-attentive Hawkes process (SAHP), Transformer Hawkes process (THP), Attentive neural Hawkes process (AttNHP), FullyNN, Intensity-free TPP (IFTPP), and ODETPP.

The diffusion model described herein are based on flow matching and rectified flows, which are variants of diffusion models with strong ties to neural ordinary differential equations (ODE). The flow matching technique is described by “Flow Matching for Generative Modeling,” of Lipman et al., 2023 (arXiv:2210.02747), the entire contents of which are incorporated herein by reference in their entirety. The rectified flow technique is described by “Flow Straight and Fast: Learning to Generate and Transfer Data with Rectified Flow,” of Lui et al., 2022 (arXiv:2209.03003), the entire contents of which are incorporated herein by reference in their entirety. These techniques allow for simulation-free training and efficient sampling using ODE solvers. The generative process of both techniques is a mapping from noise to data defined by solving the following ordinary differential equation (ODE):

$${\dot{x}}_{s} = {v}_{θ} ( {x}_{s} , s ) \qquad ( 1 )$$

where v_{θ}(xₛ,x) is a learnable function modeling a, usually intractable, vector field that generates the probability path between data x₀ and Gaussian noise x₁. Such a vector field can be constructed by marginalizing over conditional vector fields which are tractable and then generating the conditional probability paths by interpolating between data and noise with one end fixed. The parameters of v_{θ}(xₛ,x) can be directly learned by directly regressing the conditional vector fields.

Consider the following interpolation between data and noise as an example:

$${x}_{s} ( {x}_{0} , ϵ ) = α ( s ) {x}_{0} + β ( s ) ϵ \qquad ( 2 )$$

where α(s): [0,1]→[0,1] is non-increasing and continuously differentiable function satisfying α(0)=1 and α(1)=0 and β(s):[0,1]→[0,1] is non-decreasing and continuously differentiable satisfying β(0)=0 and β(1)=1. ϵ is standard Gaussian noise, and x₀ is the data distribution with no noise. It is possible to define a conditional flow ψₛ(⋅|ϵ):=xₛ(x₀, ϵ) which models the evolution of the underlying distribution xₛ and can be used to derive a conditional vector field generating probability paths from data x₀ to a given sample of ϵ. Based on the conditional flow matching objective, v_{θ}(xₛ,s) can be trained by minimizing the following objective:

$${𝔼}_{s ∼ u ( 0 , 1 \} , ϵ , {x}_{0}} [ {‖ {v}_{θ} ( {x}_{s} ( {x}_{0} , ϵ ) , s ) - {u}_{s} ( {x}_{s} ( {x}_{0} , ϵ ) \vert ϵ ‖}^{2} ] \qquad ( 3 )$$

where uₛ(xₛ|ϵ)=ψ′(ψ⁻¹(xₛ|ϵ)|ϵ) is the conditional vector field. It is worth noting that in the special case of α(s)=1−s, β(s)=s, the approach is equivalent to rectified flows. The current diffusion models with asynchronous noise schedules are formulated by extending the scalar coefficients α(s) and β(s) to matrices.

Diffusion models allow for high-quality generation of data from various domains using progressive denoising. The work of TabSyn described in “Mixed-Type Tabular Data Synthesis with Score-based Diffusion in Latent Space,” of Zhang et al., 2024, (arXiv:2310.09656), the entire contents of which are incorporated herein by reference in their entirety, extends this to the generation of tabular data. The authors considered tables with N numerical columns and M categorical columns, and trained a variational auto-encoder (VAE) to transform each table row into latent vectors. Finally, the authors trained a score-based diffusion model to generate latent rows. As a result, TabSyn excels at filling in missing data and creating high-quality synthetic data quickly. A similar approach of encoding event sequences to a latent space and then generating events in the latent space using a diffusion model before decoding the latent events can be used.

In modeling event sequence data such as temporal point processes (TPPs), the objective is to learn the distribution of future events conditioned on past events. This motivates the adoption of generative models, such as diffusion models, which are trained to approximate the underlying data distribution. The current approach leverages asynchronous noise schedules to enable more flexible and computationally efficient conditional generation, wherein the model generates future events based on partial observations of preceding data. The current approach provides greater flexibility by allowing for customizable noise schedules. To support these customizable noise schedules, a set of sufficient conditions that the noise schedule must satisfy are established to ensure the model's ability to perform asynchronous generation effectively.

A diagonal-matrix-valued time-varying coefficient A(s) is introduced with A(s)∈(H¹[0,1])^{n×n}. That is, every scalar element of A(s) is in the Sobolev space H¹[0,1]. Further, A(s) satisfies the conditions A(0)=I and A(1)=0, to parameterize the interpolation in the flow-matching formulation:

$${x}_{s} ( {x}_{0} , ϵ ) = A ( s ) {x}_{0} + ( I - A ( s ) ) ϵ \qquad ( 4 )$$

The extension of a single scalar α(s) to A(s) allows more fine-grained control to be applied on the speed of interpolation between data and noise to different parts of the data. To derive an objective function, the continuous flow-matching framework is extended by first defining a flow ψₛ(⋅|ϵ):=xₛ(x₀, ϵ). The flow is conditioned on the noise ϵ instead of the original data x₀.

The Continuous flow-matching framework described in “Flow Matching for Generative Modeling” characterizes the diffusion processes by defining a flow ψₛ(⋅|ϵ) and the corresponding vector field. This framework operates on the assumption that the interpolation between data and noise is governed by a known function of s. A critical assumption in the flow-matching framework is that the flow is invertible. However, this assumption is not always satisfied in the asynchronous formulation, presenting a significant challenge when extending flow-matching to the asynchronous setting. To address this, theoretical results are provided that relax this assumption, ensuring the framework remains applicable in scenarios where invertibility does not hold.

Before extending the scalar coefficient α(s) to a matrix-valued coefficient A(s), some sufficient conditions for scalar coefficients α(s) to satisfy for flow-matching are first considered. Particularly, it is noted that α(s) satisfies:
1. the boundary conditions α(0)=1, and α(1)=0
2. the non-negativity condition that α(s)≥1 for s∈[0,1],
3. the monotone non-increasing condition α(s)<α(s′) if s≥s′,
4. the continuity condition.

The conditions α(s) are used to determine sufficient conditions for A(s) as highlighted in the following lemmas.

Lemma 1: The flow ψₛ(xₛ|ϵ) in Equation 4 governed by a matrix-valued coefficient A(s)∈(H¹[0,1])^{n×n} remains valid as long as the following conditions are met:
1. A(s)satisfies the boundary conditions: A(0)=I, A(1)=0;
2. A(s) is positive semi-definite for all s∈[0,1];
3. A(s) is monotone non-increasing i.e ∥A(s)x∥≤∥A(s′)x∥ for all x∈ [symbol] ⁿ if s≥s′;
4. A(s) is continuous and weakly differentiable for all s∈[0,1]

These conditions ensure that the flow-matching is well-posed even for asynchronous noise schedules, as the transformation A(s) preserves the essential properties of flow-matching.

Lemma 2: The properties of the marginal vector field v_{θ}(xₛ, |A(s)) still hold even if the invertible assumptions of A(s) are relaxed as long as the conditions of Lemma.1 hold. Properties of flow-matching may be characterized as follows:
1. The marginal vector field v_{θ}(xₛ, |A(s)) can be constructed by marginalizing over the conditional vector field u(xₛ, |ϵ) that generates the flow.
2. The training objective for the marginal vector field v_{θ}(xₛ, |A(s)) can be expressed in terms of the conditional vector field u(xₛ, |ϵ).
3. The conditional vector field u(xₛ, |ϵ) can be derived in closed form.

To characterize the flow ψₛ(xₛ|ϵ) as an ODE, the conditional probability path formula described in “Flow Matching for Generative Modeling” can be considered.

$$u ( {x}_{s} , \vert ϵ ) = {ψ}_{s}^{′} ( {ψ}_{s}^{- 1} ( {x}_{s} \vert ϵ ) \vert ϵ ) \qquad ( 5 )$$

ψ′ₛ(xₛ|ϵ) can be computed and ψₛ⁻¹(xₛ|ϵ) defined as follows:

$${ψ}_{s}^{′} ( {x}_{s} \vert ϵ ) = {A}^{′} ( s ) {x}_{s} - {A}^{′} ( s ) ϵ \qquad ( 6 )$$

$${ψ}_{s}^{- 1} ( {x}_{s} \vert ϵ ) := {A ( s )}^{†} ( {x}_{s} - ϵ ) + ϵ \qquad ( 7 )$$

where A(s)^{†} is the Moore-Penrose Pseudo-Inverse of A(s).

Lemma 3: No assumptions are made about A(s) being differentiable at the points where the diffusion of the scalar elements of xₛ starts or ends. Consequently, A(s) may not be differentiable at finitely many points in s. A′(s) is considered as the weak derivative of A(s), which is guaranteed to exist under the conditions of A(s) being continuous and piecewise-differentiable.

Lemma 4: The inverse flow ψₛ⁻¹(xₛ|ϵ):=A(s)^{†}(xₛ−ϵ)+ϵ is well-posed and reconstructs all of the partially-diffused elements of xₛ if A(s) satisfies the conditions in Lemma 1 and is pseudo-invertible for all s∈[0,1]. Formally, ψₛ⁻¹(xₛ|ϵ) is left-invertible i.e. ψₛ(ψₛ⁻¹(xₛ|ϵ)|ϵ)=xₛ.

Plugging the derivative and inverse terms into the flow-matching formulation gives the desired vector field:

$$\frac{d}{d s} {x}_{s} ( \cdot \vert ϵ ) = {A}^{′} ( s ) {A ( s )}^{†} [ {x}_{s} - ϵ ] \qquad ( 8 )$$

$$≡ {A}^{′} ( s ) [ {x}_{0} - ϵ ] \qquad ( 9 )$$

Because A(s)^{†} has multiple asymptotes in s∈[0,1], solving the ODE in Equation (8) numerically is computationally challenging. Equation 9 can be used in place of equation (8) in order to more efficiently compute the desired vector field. To establish the equivalence in the vector fields, the following proposition is introduced:
Assume A(s)∈(H¹[0,1])^{n×n} is pseudo-invertible and weakly differentiable for all s∈[0,1]. Then the vector fields A′(s)A(s)^{†}[xₛ−ϵ] and A′(s)[x₀−ϵ] are equivalent.

Since the asynchronous noise schedule A(s) is decided prior to training, it is not necessary to train the model to learn it. Instead, the flow model v_{θ}(xₛ, |A(s)) is trained to predict x₀−ϵ. This model can be trained by minimizing the conditional flow-matching objective:

$${{𝔼}_{s , {x}_{0} ∼ {p}_{d a t a} , ϵ ∼ N ( 0 , I )} [ ‖ {A}^{′} ( s ) [ ( {x}_{0} - ϵ ) - {v}_{θ} ( {x}_{s} ( {x}_{0} , ϵ ) , A ( s ) ) ‖ ]}^{2} \qquad ( 10 )$$

Data is generated by solving the following ODE:

$${\dot{x}}_{s} = {A}^{′} ( s ) {v}_{θ} ( {x}_{s} , A ( s ) ) \qquad ( 11 )$$

from s=1 to s=0 with initial condition x₁ sampled from [symbol] (0, I)

For numerical methods, A′(s) is defined at points of non-differentiability as the left-hand derivative

$${lim}_{{s}^{′} \to s} {A}^{′} ( {s}^{′} ) ,$$

ensuring consistency with the piecewise-defined nature of A(s). For piecewise-linear continuous functions A(s), solving the ODE in Equation 9 with known x₀ and ϵ using this method restores x₀ with zero numerical error.

The implementation and methods used to perform generation and prediction with asynchronous noise schedules are described further below. A diffusion transformer (DiT) model is modified to take an asynchronous noise schedule A(s) as an input instead of the timestep s that is usually used. Further, the ODE used to generate data in the DiT model is replaced with the one derived in equation 9. Lastly, when performing predictions, the generation process at a flow time s≤1, which is when the prediction window starts generating, instead of s=1 as done in synchronous flow. By starting the generation process at a flow time of s≤1 can reduce the computations needed compared to starting the computation at s=1.

A unique challenge of diffusing TPP sequences lies in the necessity of modeling discrete and continuous data simultaneously with the event time being continuous scalars while event type being categorical variables. This challenge is overcome by applying the diffusion model to the latent space of TPP sequences. Specifically, a β-VAE (variational autoencoder) with an encoder E_{φ}(⋅) maps each z⁽ⁱ⁾=(τ⁽ⁱ⁾, k⁽ⁱ⁾) to a latent variable x⁽ⁱ⁾=E_{φ}(z⁽ⁱ⁾) following a Gaussian distribution with mean value denoted by x⁽ⁱ⁾. A decoder D_{φ}(⋅) of the β-VAE is trained to decode x⁽ⁱ⁾ to a reconstructed event z⁽ⁱ⁾:=(\tilde{τ}⁽ⁱ⁾, \tilde{K}⁽ⁱ⁾)=D_{φ}(x⁽ⁱ⁾). The β-VAE is trained with a reconstruction loss and a KL-divergence term that regularizes the landscape of the latent space:

$${ℒ}_{A E} ( {z}^{( i )} ) = {l}_{r e c o n} ( {z}^{( i )} , {\tilde{z}}^{( i )} ) + β {l}_{K L} \qquad ( 12 )$$

$$= {( {τ}^{( i )} - {\tilde{τ}}^{( i )} )}^{2} + CrossEntropy ( {k}^{( i )} , {\tilde{K}}^{( i )} ) + β {l}_{K L} \qquad ( 13 )$$

where l_{recon}(⋅,⋅) consists of a mean square error loss for reconstructing the inter-event time c(0, and a cross-entropy loss for reconstructing the event type k⁽ⁱ⁾. β is a hyper-parameter tuning the strength of regularization by KL divergence between X and a standard Gaussian distribution. Various choices of β were considered and used to evaluate the faithfulness of event reconstruction from the latent space on a held-out test set. The results are highlighted in Tables 1 and 2 below.

With a decoder capable of faithfully reconstructing events from the latent space, diffusion models are applied to model the joint distribution of the events in the latent space, namely x={x⁽¹⁾, x⁽²⁾, . . . , x⁽ⁿ⁾}.

Let N be the maximum number of events the latent diffusion model could generate and d be the dimension of each latent event x⁽ⁱ⁾ encoding event z⁽ⁱ⁾. The diffusion model would generate a latent vector of maximum dimension N. Given a sequence of events of length n, the asynchronous matrix A(s) may be defined as:

$${[ A ( s ) ]}_{i i} = clip ( \frac{{s}_{e n d}^{( i )} - s}{{s}_{e n d}^{( i )} - {s}_{s t a r t}^{( i )}} , min = 0 , max = 1 ) \qquad ( 14 )$$

$$where$$

$${s}_{start}^{( i )} = \frac{N - i}{2 N - 1} , {s}_{end}^{( i )} = \frac{2 N - i}{2 N - 1} , \qquad ( 15 )$$

[A(s)]ᵢᵢ is the ith diagonal block in A(s) of size d×d for i≤n<n and A(s)=0 elsewhere. The choice of such noise schedule indicates that when s is between

$${s}_{start}^{( i )}$$

and

$${s}_{end}^{( i )} ,$$

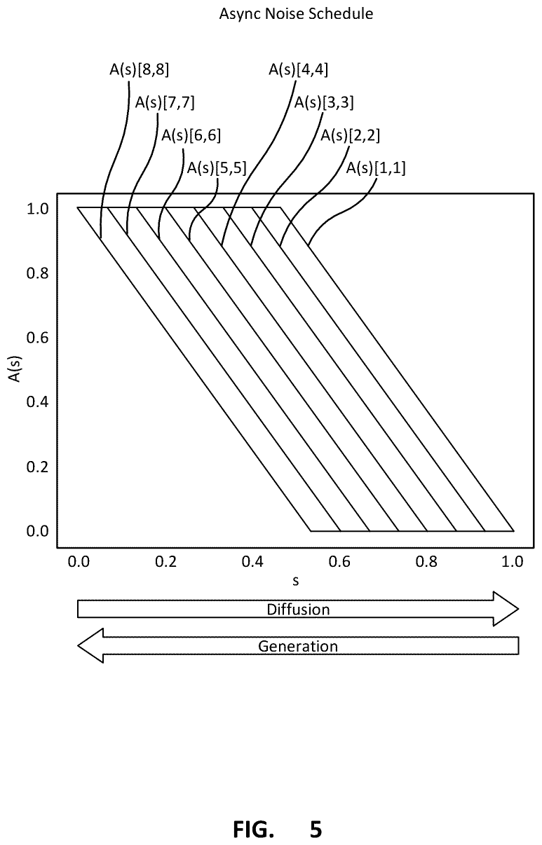

the latent representation of the ith event is being diffused from data to Gaussian noise, or from Gaussian noise to data. An example is plotted in FIG. 5 which depicts an asynchronous noise schedule. The asynchronous noise schedule depicted in FIG. 5 is used for performing diffusion on an event sequence with 8 events. The noise schedule shows that the last event (event 8) is the first event to be completely diffused (at flow time

$$s = \frac{8}{15} ) .$$

The first event (event 1) is the last event to start diffusing (at

$$s = \frac{7}{15} )$$

and be completely diffused (at s=1). Thus, in reverse-flow time generation, event 1 is the first event to be completely restored, and event 8 is the last to be completely restored.

A diffusion transformer (DiT) is trained to generate sequences of latent vectors x. A modified implementation of the DiT architecture described in “Scalable Diffusion Models with Transformers,” of Peebles & Xie 2023 (arXiv:2212.09748), the entire contents of which are incorporated herein by reference in their entirety for all purposes. The following adaptation was made to the original DiT architecture for event sequence data: the patchify and patch embedding components from the DiT model, and the time-step was adapted to A(s).

Upon initializing the model, a hyperparameter N is provided that decides the maximum length of the sequence of events that the model can generate. During training or generation of events with sequence length n<N, a causal mask is applied to the multihead self-attention, as shown in the following pseudocode. The choice of causal attention, together with the asynchronous noise schedule, reflects the sequential order of data and also allows the model to flexibly handle variable prediction window length. Accordingly, the single model can be used for next-event prediction as well as long-horizon predictions.

```
Algorithm: Masked attention in DiT
Require: Attention parameters, W_{Q}, Wk, W_{V}, Linear layer proj(·), Batch of event
sequences X (shape: [batch B, rows N, latent dim L]), mask length n
  Get attention score attn ← (W_{Q}X)(W_{K}X)^{T}
  Initiate mask (shape: [1, 1, N, N]) where mask[:,:,:n,:]=1 and mask is zero
  elsewhere.
  Set attn to -∞ at all the indices where mask == 0
  attn ← softmax(attn)
  x ← (attn)^{T} (W_{V}X)
  Return proj(x)
```

An implementation of the diffusion model, referred to as ADiff4TPP, is based on the implementation of a DiT model using rectified flows, such as described by “2-Rectifications are Enough for Straight Flows: A Theoretical Insight into Wasserstein Convergence,” of Lee et al., 2024 (arXiv:2410.14949v5)), the entire contents of which are incorporated herein by reference in their entirety for all purposes.

xₛ is sampled at an arbitrary time s∈[0,1]based on Equation 4 above, where E is Gaussian noise, and x₀ is sampled from the training dataset. The DiT model is trained with the conditional flow matching loss function in Equation 10. The trained model can be used to generate future events for a sequence of existing events.

Event forecasting can be characterized by an observation window O that precedes a prediction window P, and the goal of the model is to predict events in the prediction window while being conditioned on events in the observation window.

Let ϵ={ϵ₁, . . . , ϵ_{N}} be an initial Gaussian noise, and let {x₁, . . . , x_{N}} be a latent-space representation of an event sequence. Let n be a hyperparameter such that {1, . . . , n} is the observation window. The prediction window is {n+1, . . . , n+h}, where h, satisfying n+h≤N, represents the number of events we want to predict.

ADiff4TPP introduces a simple and intuitive method for event forecasting by leveraging the asynchronous flow-matching objective, which frames event forecasting as a generative process for future events. This objective enables the derivation of a simple ODE to reconstruct preceding latent events. The vector field f(x(s), s) is defined element-wise as:

$${f}_{i} ( x ( s ) , s ) = f ( x ) = \{ \begin{matrix}{[ {A}^{′} ( s ) ]}_{ii} ( {ϵ}_{i} - {x}_{i} ) , & i ∈ O \\ [ {{[ {A}^{′} ( s ) ]}_{ii} [ {v}_{θ} ( {x}_{s} , A ( s ) ) ]}_{i} , & i ∈ P\end{matrix} \qquad ( 16 )$$

Since [A′(s)]ᵢᵢ(ϵᵢ−xᵢ) remains constant along

$$[ {s}_{start}^{( i )} , {s}_{end}^{( i )} ,$$

ODE solvers such as Euler's method or Runge-Kutta (RK4) can solve the equation within this domain with zero numerical error.

This ODE is solved from s=s_{end} to s=sₛₜₐᵣₜ, where

$${s}_{end} = max \{ {s}_{end}^{( i )} : i ∈ P , and {s}_{start} = max \{ {s}_{start}^{( i )} : i ∈ O$$

with initial condition x(s_{end})=A(s_{end})x+(1−A(s_{end}))ϵ. The asynchronous nature of ADiff4TPP allows the ODE to be solved over the shorter timespan [sₛₜₐᵣₜ, s_{end}]instead of the full interval [0,1], improving computational efficiency. The indices of the event sequence that proceed the prediction window can be masked out by the causal mask.

Furthermore, both short- and long-horizon forecasting can be performed by solving the same ODE. This eliminates the need for repetitive next-event predictions, which are typically required in existing TPP methods. By avoiding the sequential appending of predicted events to the tensor of preceding events, ADiff4TPP significantly reduces evaluation time, making it a more efficient and scalable solution for TPP forecasting tasks.

The next-event prediction of the model was evaluated by comparing the predicted events against the true events in the test set. The ADiffTPP model predicts the event \tilde{z}ₙ=(\tilde{τ}ₙ, \tilde{k}ₙ) provided events z₁, . . . , zₙ₋₁ for i=2, . . . , N, where N is the length of the event sequence, \tilde{τ}ₙ is the predicted inter-event time, and \tilde{k}ₙ is the predicted event category.

Next-event predictions are generated by solving the ODE with the vector field provided in Equation 16. The observation window consists of indices {1, . . . , n−1}, and the prediction window consists of the index {n}. Indices greater than n are masked out. This method is detailed in the pseudo code Algorithm below.

```
Masked Next-Event Prediction
  Require: Asynchronous noise schedule A(s), pre-trained diffusion model
  v_{θ}(xₛ, A(s)), pre-trained VAE (E_{φ}(·), D_{ψ}(·)), test event sequence {z⁽¹⁾, ... , z^{(N)}}.
    Get latent event sequence {y⁽¹⁾, ... , y^{(N)}} where y⁽ⁱ⁾ = E_{φ}(z⁽ⁱ⁾) for i =
    1, ... , N
    for n = 2, ... , N do
      Sample noise ϵ = {ϵ⁽¹⁾, ... , ϵ^{(N)}} where ϵ⁽ⁱ⁾ matches the dimension of y⁽ⁱ⁾
      for all i
      Initiate mask (shape: [1, 1, N, N]) where mask [ : , : , : n, : n] = 1 and
      mask is zero elsewhere.
      Define a vector field f(x(s), s) elementwise:
            ${f}_{i} ( x ( s ) , s ) = \{ \begin{matrix}{[ {A}^{′} ( s ) ]}_{i i} ( {y}^{( i )} − {ϵ}^{( i )} ) , & i < n \\ {{[ {A}^{′} ( s ) ]}_{i i} [ ( {v}_{θ} ( {x}_{s} , A ( s ) , mask ) ]}_{i} , & i = n\end{matrix}$
      $Solve the ODE {\dot{x}}_{s} = f ( {x}_{s} , s ) from s = {s}_{end}^{( n )} to s = {s}_{start}^{( n )} using an ODE$
      $solver with initial condition {x}_{{s}_{e n d}^{( n )}} = A ( {s}_{end}^{( n )} ) y + ( I - A ( {s}_{end}^{( n )} ) ϵ$
      Obtain sequence {y⁽¹⁾, ... , y⁽ⁿ⁻¹⁾, \tilde{y}⁽ⁿ⁾} comprising the preceding latent
        events {y⁽¹⁾, ... , y⁽ⁿ⁻¹⁾} and predicted latent event {\tilde{y}⁽ⁿ⁾}
      Decode \tilde{y}⁽ⁿ⁾: D_{ψ}(\tilde{y}⁽ⁿ⁾) = \tilde{z}⁽ⁿ⁾ = (\tilde{τ}⁽ⁿ⁾, \tilde{k}⁽ⁿ⁾)
    end for
    ${Return RMSE ( {\{ {\tilde{τ}}^{( i )} , {τ}^{( i )} \}}_{i = 2}^{N} ) , E r r o r R a t e ( {\tilde{k}}^{( i )} , {k}^{( i )} \}}_{i = 2}^{N} )$
```

The performance of the model was evaluated by comparing the predicted inter-event time against the true inter-event time using the RMSE metric, and by comparing the predicted event type against the true event type using the error rate metric.

The results are provided in Table 1 below. For every dataset, ADiff4TPP achieves state-of-the-art results in predicting the next inter-event time. For three out of five datasets (Retweet, Taxi, and Taobao), ADiff4TPP achieves state-of-the-art results in predicting the next event type. The hyperparameters used for ADiff4TPP are dₗₐₜₑₙₜ=32, βₘₐₓ=0.01.

TABLE 1
RMSE of predicted inter-event time/Error Rate of predicted event
type for different datasets and models. Bold indicates state-of-the-art
results achieved by ADiff4TPP in both RMSE and error rate.

| Model | Amazon | Retweet | Taxi | Taobao | StackOverflow |
|---|---|---|---|---|---|
| RMTPP | 0.559/70.4% | 26.207/48.4% | 0.351/11.5% | 0.257/56.45% | 1.246/57.6% |
| | (0.014/0.008) | (5.650/0.030) | (0.042/0.002) | (0.073/0.000) | (0.293/0.002) |
| NHP | 0.640/70.0% | 22.511/46.1% | 0.342/13.0% | 0.168/50.7% | 1.324/73.2% |
| | (0.002/0.001) | (0.033/0.001) | (0.075/0.007) | (0.098/0.012) | (0.359/0.146) |
| SAHP | 0.517/68.0% | 21.708/46.0% | 0.335/11.9% | 0.154/53.6% | 1.327/57.7% |
| | (0.008/0.005) | (0.001/0.001) | (0.175/0.016) | (0.083/0.009) | (0.002/0.002) |
| THP | 0.550/65.4% | 26.176/40.5% | 0.375/12.7% | 0.314/54.4% | 1.424/58.0% |
| | (0.016/0.002) | (0.059/0.001) | (0.065/0.011) | (0.044/0.017) | (0.012/0.013) |
| AttNHP | 0.755/68.1% | 22.296/42.8% | 0.429/14.8% | 0.280/52.9% | 1.350/55.4% |
| | (0.185/0.011) | (1,135/0.041) | (0.012/0.027) | (0.085/0.019) | (0.018/0.001) |
| IFTTPP | 0.465/64.9% | 22.198/40.0% | 0.357/8.56% | 0.598/44.1% | 1.884/54.5% |
| | (0.001/0.001) | (0.234/0.002) | (0.013/0.0004) | (0.103/0.003) | (0.043/0.008) |
| DTPP | 0.619/65.5% | 24.680/40.3% | 0.302/12.10% | 0.587/53.3% | 1.780/60.7% |
| | (0.104/0.002) | (6.364/0.003) | (0.043/0.012) | (0.031/0.003) | (0.167/0.002) |
| ADiff4TPP | 0.407/67.5% | 17.880/39.3% | 0.299/8.46% | 0.140/42.6% | 1.226/61.3% |
| | (0.002/0.002) | (0.051/0.001) | (0.0002/0.0005) | (0.054/0.011) | (0.035/0.011) |

In addition to evaluating the performance of the ADiff4TPP model on next event prediction, the model was also evaluated for performance on long-horizon predictions. The long-horizon prediction of the model was evaluated by computing the 1−Wasserstein distance, otherwise known as the optimal transport distance (OTD) between the predicted events and the true events in the prediction interval. Long horizon predictions are generated by solving the ODE with the vector field provided in Equation 16. The observation window comprises indices {1, . . . , N−h}, and the prediction window consists of the index {N−h+1, . . . , N} where h is the horizon. This method is detailed in the pseudo code below. 3.

```
Long-Horizon Prediction
  Require: Asynchronous noise schedule A(s), pre-trained diffusion model v_{θ}(xₛ, A(s)),
  pre-trained VAE (E_{φ}(·), D_{ψ}(·)), test event sequence {z⁽¹⁾, ... , z^{(N)}}, prediction horizon sh
    Get latent event sequence {y⁽¹⁾, ... , y^{(N)}} where y⁽ⁱ⁾ = E_{φ}(z⁽ⁱ⁾) for i = 1, ... , N
  Sample noise ϵ = {ϵ⁽¹⁾, ... , ϵ^{(N)}} where ϵ⁽ⁱ⁾ matches the dimension of y⁽ⁱ⁾ for all i
  Define a vector field f (xₛ, s) elementwise:
  ${f}_{i} ( {x}_{s} , s ) = \{ \begin{matrix}{[ {A}^{′} ( s ) ]}_{i i} ( {y}^{( i )} − {ϵ}^{( i )} ) , & i \leq N − h \\ {[ {A}^{′} ( s ) ]}_{i i} [ {( {v}_{θ} ( {x}_{s} , A ( s ) ) ]}_{i} , & i > N − h\end{matrix}$
  Solve the ODE \dot{x}ₛ = f (xₛ, s), x₁ = ϵ from s = 1 to s = 0 using an ODE solver
  Obtain sequence {y⁽¹⁾, ... , y^{(N-h)}, \tilde{y}^{(N-h+1)}, \tilde{y}^{(N)}} comprising the preceding latent
  events {y⁽¹⁾, ... , y^{(N-h)}} and predicted latent events {\tilde{y}^{(N-h+1)}, \tilde{y}^{(N)}}
  Decode \tilde{y}⁽ⁱ⁾: D_{ψ}(\tilde{y}⁽ⁱ⁾) = \tilde{z}⁽ⁱ⁾ = (\tilde{τ}⁽ⁱ⁾, \tilde{k}⁽ⁱ⁾), i = N − h + 1, ... , N
  end for
$Return OTD ( {\{ {\tilde{z}}^{( i )} \}}_{i = N - h + 1}^{N} , {\{ {z}^{( i )} \}}_{i = N - h + 1}^{N} )$
```

The implementation of the OTD uses dynamic programming to compute the distance between event sequences efficiently. It separates events according to event types and finds the alignment between inter-event times for each category. The transport cost was set to 1 and the deletion cost to 1. These are the hyperparameters that determine the cost of switching the order of two events or deleting an event, respectively. The results are provided in Tabled 2 and 3 below.

| Model | Amazon | Retweet | Taxi | Taobao | StackOverflow |
|---|---|---|---|---|---|
| RMTPP | 9.880/19.671 | 9.991/19.983 | 4.012/5.961 | 8.692/15.808 | 9.463/18.735 |
| | (0.016/0.035) | (0.003/0.004) | (0.136/0.196) | (0.097/0.237) | (0.075/0.160) |
| NHP | 9.881/19.670 | 9.992/19.954 | 4.007/5.915 | 8.498/15.202 | 9.482/18.762 |
| | (0.015/0.035) | (0.003/0.008) | (0.137/0.199) | (0.099/0.248) | (0.073/0.156) |
| SAHP | 9.874/19.657 | 9.998/19.977 | 5.458/7.566 | 8.615/15.546 | 9.490/18.790 |
| | (0.016/0.035) | (0.002/0.006) | (0.113/0.162) | (0.101/0.247) | (0.072/0.156) |
| THP | 9.869/19.642 | 9.991/19.937 | 6.023/10.816 | 8.698/15.826 | 9.498/18.808 |
| | (0.017/0.037) | (0.003/0.010) | (0.094/0.163) | (0.095/0.234) | (0.069/0.148) |
| AttNHP | 9.862/19.624 | 9.981/19.925 | 3.970/5.794 | 8.216/14.659 | 9.443/18.682 |
| | (0.018/0.039) | (0.005/0.012) | (0.127/0.166) | (0.105/0.247) | (0.073/0.157) |
| IFTPP | 9.859/19.603 | 9.989/19.927 | 4.461/5.573 | 8.030/14.212 | 9.406/18.626 |
| | (0.018/0.042) | (0.003/0.011) | (0.098/0.162) | (0.104/0.245) | (0.077/0.164) |
| DTPP | 6.848/13.734 | 9.916/19.433 | 2.983/6.773 | 6.844/15.127 | 7.554/14.946 |
| | (0.010/0.024) | (0.004/0.009) | (0.013/0.019) | (0.019/0.032) | (0.020/0.036) |
| ADiff4TPP | 6.219/12.419 | 9.119/17.738 | 2.332/3.979 | 5.398/10.255 | 6.452/11.972 |
| | (0.049/0.115) | (0.017/0.051) | (0.022/0.015) | (0.086/0.065) | (0.400/0.922) |

Table 2 showing OTD results for prediction windows of 5 and 10 events. Bold indicates state-of-the-art results.

| Model | Amazon | Retweet | Taxi | Taobao | StackOverflow |
|---|---|---|---|---|---|
| RMTPP | 39.156 | 39.906 | 9.203 | 28.727 | 37.046 |
| | (0.075) | (0.012) | (0.326) | (0.506) | (0.320) |
| NHP | 39.161 | 39.745 | 9.170 | 28.056 | 37.188 |
| | (0.075) | (0.028) | (0.327) | (0.530) | (0.306) |
| SAHP | 39.065 | 39.874 | 12.784 | 28.262 | 37.232 |
| | (0.080) | (0.020) | (0.231) | (0.523) | (0.304) |
| THP | 39.069 | 39.691 | 14.308 | 28.774 | 37.116 |
| | (0.082) | (0.032) | (0.318) | (0.499) | (0.306) |
| AttNHP | 39.051 | 39.694 | 9.029 | 27.046 | 36.847 |
| | (0.083) | (0.032) | (0.240) | (0.499) | (0.323) |
| IFTPP | 38.971 | 39.705 | 8.566 | 26.243 | 36.763 |
| | (0.091) | (0.031) | (0.221) | (0.503) | (0.331) |
| DTPP | 27.603 | 29.762 | 13.830 | 32.275 | 29.188 |
| | (0.064) | (0.003) | (0.145) | (0.136) | (0.036) |
| ADiff4TPP | 24.645 | 28.028 | 6.672 | 19.152 | 22.334 |
| | (0.141) | (0.170) | (0.049) | (0.149) | (2.142) |

Table 3 showing OTD results for prediction window of 20 events

The importance of latent space representations in the ADiff4TPP model was evaluated. In particular, different choices for the KL divergence coefficient β and the latent dimensions were examined. The KL divergence coefficient was initiated to β=βₘₐₓ, and β decreased to βₘᵢₙ over the training of the VAE. The VAE training results are provided below in Tables 4 and 5. The minimum KL divergence coefficient was set to βₘᵢₙ=10⁻¹, and βₘₐₓ=1.0,0.1,0.0,0.00. The latent dimension had values of 4, 8, 16, 32 and also 2 for the retweet dataset. The latent dimension set the size to 16 and 32 and βₘₐₓ to 0.01 and 0.001 for the training of the diffusion models since these hyperparameters had the lowest reconstruction errors.

TABLE 4
Overview of the training results of VAEs in four TPP benchmark dataset with different
hyperparameters. βₘₐₓ corresponds to the weight placed on the KL Divergence term.

| | Latent | | Test MSE | Test Accuracy | KL |
|---|---|---|---|---|---|
| Dataset | Dimension | βₘₐₓ | (Time) | (Event) | Divergence |
| Taxi | 8 | 0.01 | 0.000008 | 1.00 | 1.422255 |
| Taobao | 8 | 0.01 | 0.000007 | 1.00 | 2.675954 |
| Stackoverflow | 8 | 0.01 | 0.000007 | 1.00 | 1.302106 |
| Amazon | 8 | 0.01 | 0.000004 | 1.00 | 0.546956 |
| Taxi | 8 | 0.001 | 0.000066 | 1.00 | 1.595017 |
| Taobao | 8 | 0.001 | 0.000307 | 1.00 | 1.727479 |
| Stackoverflow | 8 | 0.001 | 0.000006 | 1.00 | 1.618665 |
| Amazon | 8 | 0.001 | 0.000003 | 1.00 | 1.749470 |
| Taxi | 16 | 0.01 | 0.000004 | 1.00 | 0.660862 |
| Taobao | 16 | 0.01 | 0.000001 | 1.00 | 0.510525 |
| Stackoverflow | 16 | 0.01 | 0.000006 | 1.00 | 0.972457 |
| Amazon | 16 | 0.01 | 0.000001 | 1.00 | 0.431824 |
| Taxi | 16 | 0.001 | 0.000002 | 1.00 | 1.175252 |
| Taobao | 16 | 0.001 | 0.000002 | 1.00 | 1.826852 |
| Stackoverflow | 16 | 0.001 | 0.000003 | 1.00 | 2.593421 |
| Amazon | 16 | 0.001 | 0.000001 | 1.00 | 0.486753 |
| Taxi | 32 | 0.01 | 0.000005 | 1.00 | 0.847024 |
| Taobao | 32 | 0.01 | 0.000001 | 1.00 | 1.100021 |
| Stackoverflow | 32 | 0.01 | 0.000006 | 1.00 | 0.969485 |
| Amazon | 32 | 0.01 | 0.000001 | 1.00 | 0.226177 |
| Taxi | 32 | 0.001 | 0.000002 | 1.00 | 2.596737 |
| Taobao | 32 | 0.001 | 0.000009 | 1.00 | 3.441910 |
| Stackoverflow | 32 | 0.001 | 0.000003 | 1.00 | 2.321191 |
| Amazon | 32 | 0.001 | 0.000004 | 1.00 | 0.286039 |
| Taxi | 8 | 0.1 | 0.000036 | 1.00 | 0.464769 |
| Taobao | 8 | 0.1 | 0.000040 | 1.00 | 0.367910 |
| Stackoverflow | 8 | 0.1 | 0.000029 | 1.00 | 0.639186 |
| Amazon | 8 | 0.1 | 0.000019 | 1.00 | 0.348057 |
| Taxi | 4 | 0.01 | 0.000114 | 0.999865 | 1.591100 |
| Taobao | 4 | 0.01 | 0.000279 | 1.00 | 1.710422 |
| Stackoverflow | 4 | 0.01 | 0.000169 | 1.00 | 2.114793 |
| Amazon | 4 | 0.01 | 0.000013 | 0.999988 | 1.121674 |
| Taxi | 8 | 1.0 | 0.000106 | 1.00 | 0.282435 |
| Taobao | 8 | 1.0 | 0.000076 | 1.00 | 0.337149 |
| Stackoverflow | 8 | 1.0 | 0.000363 | 1.00 | 0.645850 |
| Amazon | 8 | 1.0 | 0.000102 | 1.00 | 0.270750 |

TABLE 5
Training results of VAEs on the Retweet dataset.

| | Latent | | Test MSE | Test Accuracy | KL |
|---|---|---|---|---|---|
| Dataset | Dimension | βₘₐₓ | (Time) | (Event) | Divergence |
| Retweet | 2 | 1.0 | 0.002049 | 1.00 | 3.173542 |
| Retweet | 2 | 0.1 | 0.014252 | 0.999804 | 3.082116 |
| Retweet | 2 | 0.01 | 0.134966 | 0.591000 | 55.257951 |
| Retweet | 2 | 0.001 | 0.004303 | 0.542401 | 158.649788 |
| Retweet | 4 | 1.0 | 0.029607 | 0.999640 | 1.486775 |
| Retweet | 4 | 0.1 | NaN | 0.519590 | NaN |
| Retweet | 4 | 0.01 | 0.000839 | 0.999967 | 8.499786 |
| Retweet | 4 | 0.001 | NaN | 0.488553 | NaN |
| Retweet | 8 | 1.0 | 0.001032 | 1.00 | 0.667470 |
| Retweet | 8 | 0.1 | 0.004570 | 1.00 | 1.273117 |
| Retweet | 8 | 0.01 | 0.000254 | 1.00 | 1.857849 |
| Retweet | 8 | 0.001 | 0.000138 | 1.00 | 4.784689 |
| Retweet | 16 | 1.0 | 0.000290 | 1.00 | 0.276919 |
| Retweet | 16 | 0.1 | 0.000208 | 1.00 | 0.810816 |
| Retweet | 16 | 0.01 | 0.000250 | 1.00 | 1.547005 |
| Retweet | 16 | 0.001 | 0.000031 | 1.00 | 2.757766 |
| Retweet | 32 | 1.0 | 0.000648 | 1.00 | 0.185612 |
| Retweet | 32 | 0.1 | 0.000036 | 1.00 | 0.560295 |
| Retweet | 32 | 0.01 | 0.000081 | 1.00 | 1.235596 |
| Retweet | 32 | 0.001 | 0.000015 | 1.00 | 2.917406 |

Further, the importance of masking in the DiT model was evaluated by comparing the test results of DiT with and without masking. The results showed that the DiT model trained and tested with causal masking led to improved results in the test set. This is believed to be because causal masking allows events to be discarded that exceed the window of the sequence or the prediction window, thus giving it less importance.

As described above, future events can be predicted or generated for TPP sequences using diffusion models. The diffusion model uses a flexible asynchronous noise schedule in the diffusion/generation process which allows the events to be generated efficiently by denoising samples over a smaller time step since not all events are generated at the same rate due to the asynchronous noise schedule.

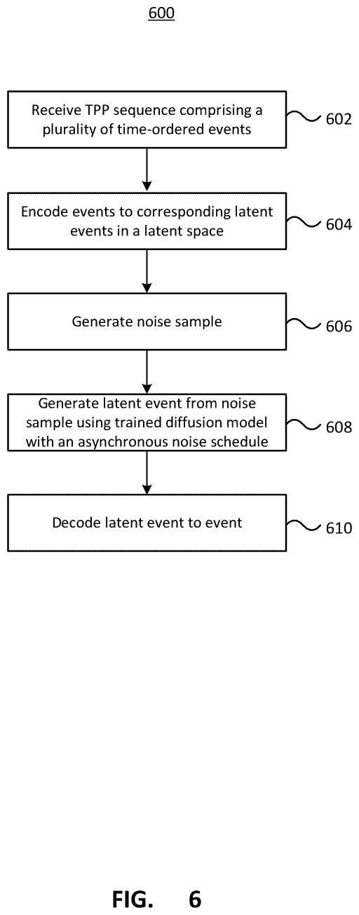

FIG. 6 depicts a method of generating future events for a TPP sequence using a diffusion model. The method receives a TPP sequence comprising a plurality of time-ordered events (602). The TPP sequence can be received in various ways including for example by receiving at the computing system executing the ADiff4TPP model, the sequence from one or more external or internal components. Additionally or alternatively, receiving the sequence may include retrieving the sequence from one or more locations. Each event in the TPP sequence includes an associated time and some categorical data. The sequence is a time ordered sequence of events in which each event occurs at a particular time. The events of the sequence, or a portion of the sequence, are encoded to corresponding events in a latent space (604). The encoding is performed by an encoder of a variational autoencoder (VAE). A noise sample is generated (606). The noise sample may comprise a number of individual noise samples corresponding to the event sequence length that can be generated by the diffusion model. A latent event in the latent event space is generated from the noise sample using a trained diffusion model with an asynchronous noise schedule (608). The diffusion model generates the latent events by removing noise from the noise sample according to the asynchronous noise schedule until all of the noise is removed. The denoising by the diffusion model is conditioned by the latent events corresponding to the received TPP sequence, or a portion of the TPP sequence. The diffusion model removes the noise in a number of flow time steps between s=1 and s=0. The asynchronous noise schedule allows different latent events to be fully denoised at different flow time steps and as such does not need to be computed over all time steps between s=1 and s=0 but rather can be computed over s=s_{end} and s=sₛₜₐᵣₜ where s_{end}≤1 and sₛₜₐᵣₜ≥0. Once the latent event, or events are generated, they can be decoded to corresponding events (610) using a decoder of the VAE.

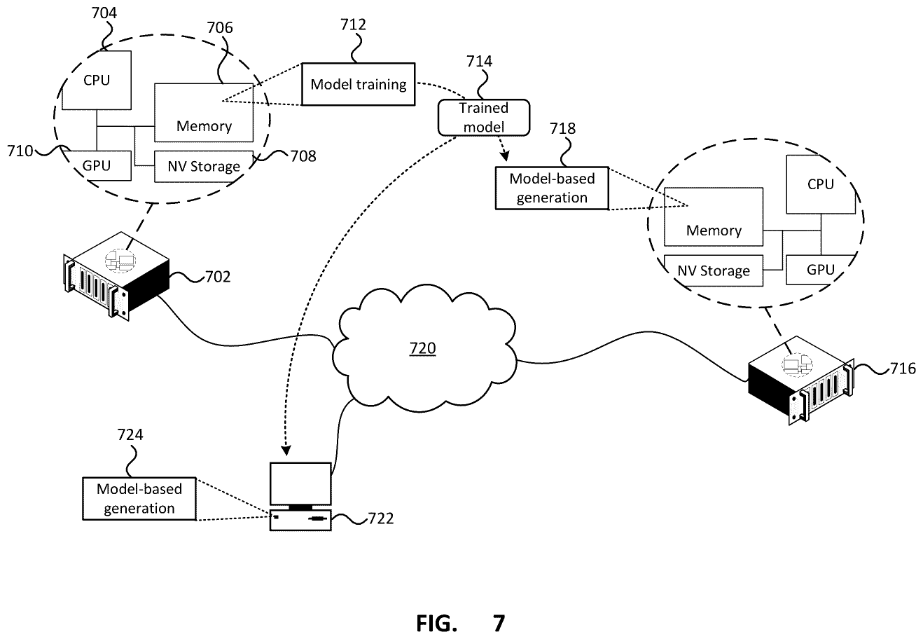

FIG. 7 depicts systems for training and using a diffusion model with TPP sequences. The system 700 includes one or more computing devices, depicted as computing devices 702, 716 and 722. Although depicted as separate computing devices, the functionality described could be combined into fewer computing devices, or possibly provided by additional computing devices. Regardless, computing device 702 comprise a processor 704 for executing instructions and a memory for storing instructions 706 to be executed. The computing device may further include non-volatile storage 708 for storing data, which may include instructions. Additionally, the system 702 may include a graphical processing unit or other specialized computing hardware. The processing time required by training the models described herein may be improved through the use of such specialized computing hardware. It will be appreciated that the other computing devices 716, 722 may have similar components. As depicted all of the computing devices are coupled together by one or more communication networks 720. Computing device 702 is depicted as providing model training functionality 712 which may be used to train the model as described above. The model training may train both the diffusion model and the encoder/decoder of the VAE. Once trained, the model 714 can be deployed to other computing devices for use by model-based generation functionality 718, 722. The model-based generation functionality uses the trained model to generate or predict events based on a TPP sequence. As depicted, the trained model may be deployed to various different computing devices.

It will be appreciated by one of ordinary skill in the art that the system and components shown in FIGS. 1-7 may include components and/or steps not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code may be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor may be for use in, e.g., a communications device or other device described in the present application.

Numerous additional variations on the methods and apparatus of the various embodiments described above will be apparent to those skilled in the art in view of the above description. Such variations are to be considered within the scope of the current disclosure.

What is claimed is:

1. A method of generating a plurality of predicted events in a time series, the method comprising:
receiving an observation series of events, z, comprising a plurality of events each associated with an event type of a plurality of defined event types and an event time, where:
$$z = \{ {z}^{( 1 )} , {z}^{( 2 )} , … , {z}^{( N )} ;$$
$${z}^{( i )} = ( {τ}^{( i )} , {k}^{( i )} ) ;$$
k⁽ⁱ⁾ is the event type of the ith event; and
τ⁽ⁱ⁾ is an event time of the ith event;
generating a latent event sequence, x, by encoding each event of the observation series of events to corresponding observation latent events in a latent space using a trained encoder, E_{Ø}, of a variational autoencoder, where:
$$x = \{ {x}^{( 1 )} , {x}^{( 2 )} , … , {x}^{( N )} \} ;$$
$${x}^{( 1 )} = {E}_{∅} ( {z}^{( i )} )$$
generating a noise sample ϵ={ϵ₁, . . . , ϵ_{N+h}}, where h is a number of events to predict;
denoising the noise samples to generate a series of h latent events using a diffusion model conditioned on the received observation series x, the diffusion model applying an asynchronous noise schedule to denoise different samples at different rates; and
decoding the h latent events to a prediction series of events using a trained decoder, D_{ψ}, of the variational autoencoder.

2. The method of claim 1, wherein denoising the noise samples generates a latent event sequence y={y⁽¹⁾, y⁽²⁾, . . . , y^{(N+h)}} where {y⁽¹⁾, y⁽²⁾, . . . , y^{(N)}}{x⁽¹⁾, x⁽²⁾, . . . x^{(N)}} and {y^{(N+1)}, . . . , y^{(N+h)}} are the predicted h latent events.

3. The method of claim 2, wherein the asynchronous noise schedule, A(s), is a diagonal-matrix-valued time-varying coefficient.

4. The method of claim 3, wherein A(s)∈(H¹[0,1])^{n×n}.

5. The method of claim 4, wherein:
$$A ( 0 ) = I ;$$
$$A ( 1 ) = 0 ;$$
A(s) is positive semi-definite for all s∈[0,1];
∥A(s)x∥≤∥A(s′)x∥ for all x∈Rⁿ if s≥s′; and
A(s) is continuous and weakly differentiable for all s∈[0,1].

6. The method of claim 5, wherein denoising the noise samples comprises solving an ordinary differential equation (ODE):
$${\dot{x}}_{s} = {v}_{θ} ( {x}_{s} , s ) ;$$
where:
\dot{x}ₛ is a denoised latent event at flow time s; and
v_{θ}(xₛ, x) is a learnable function modeling a vector field that generates a probability path between data x₀ and Gaussian noise x₁.

7. The method of claim 1, wherein h≥1.

8. The method of claim 1, wherein the h latent events are generated over time steps between s=s_{end} and s=sₛₜₐᵣₜ where s_{end}≤1 and sₛₜₐᵣₜ≥0.

9. The method of claim 8, wherein at least one of:
$${s}_{end} < 1 ; and$$
$${s}_{start} > 0.$$

10. The method of claim 9, wherein the h latent events are fully denoised at s=sₛₜₐᵣₜ.

11. The method of claim 1, wherein the noise sample is Gaussian noise.

12. A system comprising:
a processor for executing instructions; and
a memory storing instructions, which when executed by the processor configure the system to perform a method comprising:
receiving an observation series of events, z, comprising a plurality of events each associated with an event type of a plurality of defined event types and an event time, where:
$$z = \{ {z}^{( 1 )} , {z}^{( 2 )} , … , {z}^{( N )} ;$$
$${z}^{( i )} = ( {τ}^{( i )} , {k}^{( i )} ) ;$$
k⁽ⁱ⁾ is the event type of the ith event; and
τ⁽ⁱ⁾ is an event time of the ith event;
generating a latent event sequence, x, by encoding each event of the observation series of events to corresponding observation latent events in a latent space using a trained encoder, E_{Ø}, of a variational autoencoder, where:
$$x = \{ {x}^{( 1 )} , {x}^{( 2 )} , … , {x}^{( N )} \} ;$$
$${x}^{( 1 )} = {E}_{∅} ( {z}^{( i )} )$$
generating a noise sample ϵ={ϵ₁, . . . , ϵ_{N+h}}, where h is a number of events to predict;
denoising the noise samples to generate a series of h latent events using a diffusion model conditioned on the received observation series x, the diffusion model applying an asynchronous noise schedule to denoise different samples at different rates; and
decoding the h latent events to a prediction series of events using a trained decoder, D_{ψ}, of the variational autoencoder.

13. The system of claim 12, wherein denoising the noise samples generates a latent event sequence y={y⁽¹⁾, y⁽²⁾, . . . , y^{(N+h)}} where {y⁽¹⁾, y⁽²⁾, . . . , y^{(N)}}={x⁽¹⁾, x⁽²⁾, . . . , x^{(N)}} and {y^{(N+1)}, . . . , y^{(N+h)}} are the predicted h latent events.

14. The system of claim 13, wherein the asynchronous noise schedule, A(s), is a diagonal-matrix-valued time-varying coefficient.

15. The system of claim 14, wherein A(s)∈(H¹[0,1])^{n×n}.

16. The system of claim 15, wherein:
$$A ( 0 ) = I ;$$
$$A ( 1 ) = 0 ;$$
A(s) is positive semi-definite for all s∈[0,1];
∥A(s)x∥≤∥A(s′)x∥ for all x∈Rⁿ if s≥s′; and
A(s) is continuous and weakly differentiable for all s∈[0,1].

17. The system of claim 16, wherein denoising the noise samples comprises solving an ordinary differential equation (ODE):
$${\dot{x}}_{s} = {v}_{θ} ( {x}_{s} , s ) ;$$
where:
\dot{x}ₛ is a denoised latent event at flow time s; and
v_{θ}(xₛ, x) is a learnable function modeling a vector field that generates a probability path between data x₀ and Gaussian noise x₁.

18. The system of claim 12, wherein h≥1.

19. The method of claim 12, wherein the h latent events are generated over time steps between s=s_{end} and s=sₛₜₐᵣₜ where s_{end}≤1 and sₛₜₐᵣₜ≥0.

20. The system of claim 19, wherein at least one of:
$${s}_{end} < 1 ; and$$
$${s}_{start} > 0 ,$$
and
wherein the h latent events are fully denoised at s=sₛₜₐᵣₜ.
